(19) United States
(12) Patent Application Publication
(10) Pub. No.: US 2017/0301374 A1
(43) Pub. Date: Oct. 19, 2017

(54) POSITIVE LATCHING OF TAPE CARTRIDGES IN TAPE LIBRARY MAGAZINES

(71) Applicant: International Business Machines Corporation, Armonk, NY (US)

(72) Inventor: Lance W. Curtis, Tucson, AZ (US)

(73) Assignee: International Business Machines Corporation, Armonk, NY (US)

(21) Appl. No.: 15/099,726

(22) Filed: Apr. 15, 2016

(51) Int. Cl. G11B 33/04

(52) U.S. Cl. CPC G11B 33/04

(57) ABSTRACT

An apparatus is disclosed to ensure positive latching of tape cartridges in tape library magazines. In one embodiment, such an apparatus includes a tape library defining a channel to receive a tape library magazine accommodating one or more tape cartridges. A protruding member is provided within the channel to urge the one or more tape cartridges into the tape library magazine as the tape library magazine slides into the channel. The protruding member may include a cam-like member, an arm, a roller, or other suitable structures to urge the one or more tape cartridges into the tape library magazine. The protruding member ensures engagement of a latching mechanism configured to retain the one or more tape cartridges within the tape library magazine. A corresponding system and method are also disclosed.

### BACKGROUND

### Field of the Invention

This invention relates to apparatus and methods to ensure positive latching of tape cartridges in tape library magazines.

### Background of the Invention

A tape library is an automated data storage system used to store and retrieve data on magnetic tape cartridges. A tape library typically includes one or more tape drives for reading and writing information to magnetic tape cartridges, access ports for entering and removing cartridges from the tape library, and a moving robot (i.e., an accessor) to physically transport tape cartridges between storage cells, drives, and access ports. For example, the IBM 3572 is an LTO tape library that holds one tape drive and up to ten tape cartridges. The tape cartridges are placed in a magazine that can be inserted into or removed from a channel in the tape library. Once the magazine is inserted into the tape library, the tape cartridges are accessible to an accessor inside the library.

The magazine used by the IBM 3572 employs “high density” slot technology, which enables two cartridges to be inserted into the same slot, also referred to as a “tier.” This enables much greater storage density in the tape library. Each high density slot is spring-loaded to enable a second cartridge to be pushed into the slot after a first cartridge is loaded. The first cartridge is pushed further into the slot by the second cartridge. When the second cartridge is removed, the first cartridge is pushed to the front of the slot by the spring, thereby allowing it to be grabbed by the accessor. In the IBM 3572, there are five slots in the magazine, each holding up to two cartridges. At the front of each slot is a latch that holds the tape cartridges against the spring. This latch maintains the tape cartridges at a correct position at the front of the slot so that they can be grabbed and manipulated by the library accessor.

Unfortunately, because tape cartridges are inserted into the magazine by hand, operator error may cause problems with the magazine latching function. If the operator is not diligent in pushing a tape cartridge all the way into a slot, the latch may not close properly. This may create a partial latch condition. If a cartridge is not fully latched, the latch may open, allowing the tape cartridge to protrude out of the magazine beyond the latch point. This may occur when the magazine is subjected to shock or vibration, such as when the magazine is inserted into the tape library. If the latch opens when the magazine is inserted into the tape library, the protruding cartridge may prevent the removal of the magazine from the tape library. A protruding cartridge may also interfere with movement of the accessor inside the tape library, possibly causing an accessor movement error. Any of these scenarios has the potential to interfere with a scheduled backup and/or prevent a customer from accessing data on the tape library. In certain cases, the scenarios described above may damage the tape library, potentially causing loss of the tape library and/or the data contained therein.

In view of the foregoing, what are needed are apparatus and methods to prevent cases of operator error that may cause the latching malfunction and associated problems described above. Ideally, such apparatus and methods will be simple, effective, and inexpensive.

### SUMMARY

The invention has been developed in response to the present state of the art and, in particular, in response to the problems and needs in the art that have not yet been fully solved by currently available apparatus and methods. Accordingly, the invention has been developed to provide apparatus and methods to ensure positive latching of tape cartridges in tape library magazines. The features and advantages of the invention will become more fully apparent from the following description and appended claims, or may be learned by practice of the invention as set forth hereinafter.

Consistent with the foregoing, an apparatus is disclosed to ensure positive latching of tape cartridges in tape library magazines. In one embodiment, such an apparatus includes a channel to receive a tape library magazine accommodating one or more tape cartridges. A protruding member is provided within the channel to urge the one or more tape cartridges into the tape library magazine as the tape library magazine slides into the channel. The protruding member may include a cam-like member, an arm, a roller, or other suitable structures to urge the one or more tape cartridges into the tape library magazine. The protruding member ensures engagement of a latching mechanism configured to retain the one or more tape cartridges within the tape library magazine.

A corresponding system and method are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a perspective view showing one embodiment of a tape library receiving a tape library magazine;

FIG. 2 is a perspective view showing one embodiment of a tape library magazine;

FIG. 3 is a side view showing proper and improper engagement of a latching mechanism configured to retain a tape cartridge within a tape library magazine;

FIG. 4 is a first cutaway top view showing a protruding member configured to urge a tape cartridge into a tape library magazine as the tape library magazine slides into a tape library;

FIG. 5 is a second cutaway top view showing the protruding member urging the tape cartridge into the tape library magazine as the tape library magazine slides into the tape library;

FIG. 6A shows one embodiment of a cam-like protruding member to urge a tape cartridge into a tape library magazine;

FIG. 6B shows one embodiment of a protruding member incorporating a roller;

FIG. 6C shows one embodiment of a protruding member incorporating multiple rollers;

FIG. 6D shows one embodiment of a protruding member using a biasing member to urge the protruding member against a tape cartridge;

FIG. 6E shows one embodiment of a protruding member that acts as its own biasing member; and

FIG. 6F shows one embodiment of a protruding member using a cam wheel to urge a tape cartridge into a tape library magazine.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

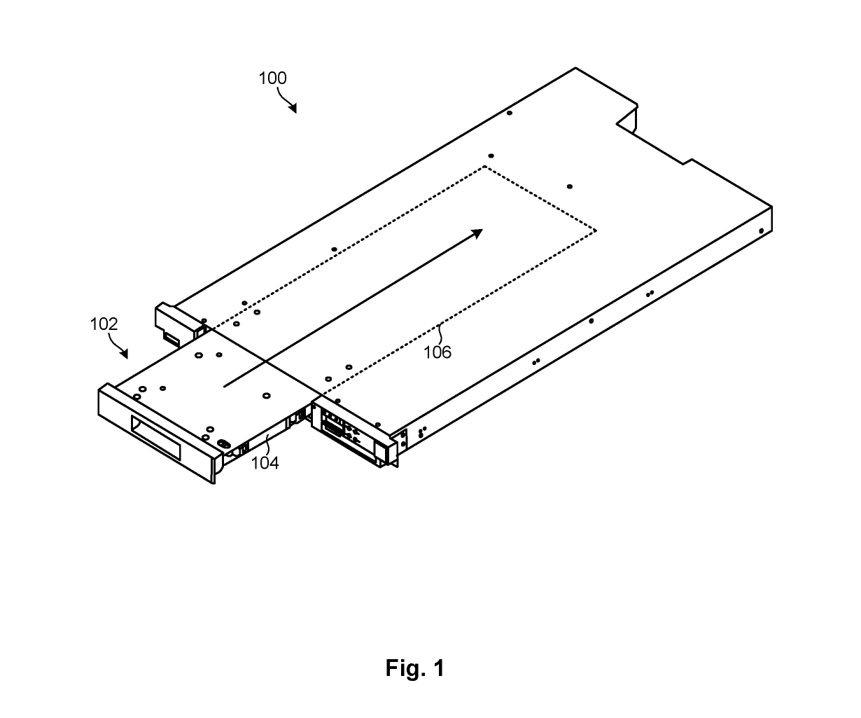

Referring to FIG. 1, one example of a tape library 100 is illustrated. In this embodiment, the tape library 100 is configured to receive a magazine 102 holding multiple tape cartridges 104. An accessor (not shown) within the tape library 100 may load/unload the tape cartridges 104 from the tape library magazine 102 and transport these tape cartridges 104 to and from a tape drive (not shown) for accessing data thereon. As shown in FIG. 1, the tape library magazine 102 may slide into a channel 106 of the tape library 100. Once the tape library magazine 102 is fully inserted into the tape library 100, the tape cartridges 104 may be accessible to the accessor inside the tape library 100.

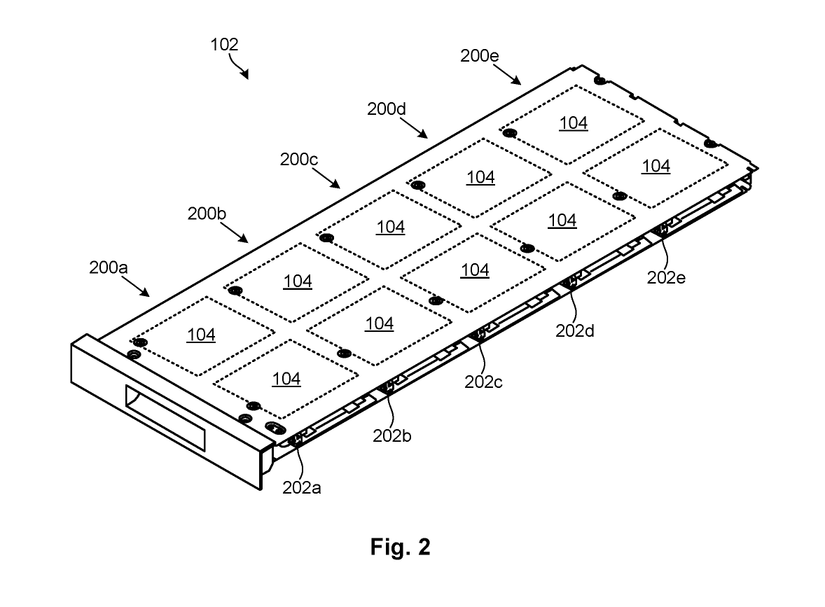

Referring to FIG. 2, one embodiment of a tape library magazine 102 for use with a tape library 100 is illustrated. The illustrated tape library magazine 102 employs “high density” slot technology, which enables two tape cartridges 104 to be inserted into the same slot 200, also referred to as a “tier” 200. This enables much greater storage density in the tape library 100. Each high density slot 200 is spring-loaded to enable a second tape cartridge 104 to be pushed into the slot 200 after a first tape cartridge 104 is loaded. The first tape cartridge 104 is pushed further into the slot 200 by the second tape cartridge 104. When the second tape cartridge 104 is removed, the first tape cartridge 104 is pushed to the front of the slot 200 by the spring, thereby allowing it to be grabbed by the accessor. In the illustrated embodiment, there are five slots 200a-e in the tape library magazine 102, each holding up to two tape cartridges 104. The approximate position of the tape cartridges 104 within the tape library magazine 102 are shown with dotted lines. At the front of each slot 200 is a latch 202 that holds the tape cartridges 104 against the spring associated with the slot 200. This latch 202 stops the tape cartridges 104 at a specified position at a front of the slot 200 so that they can be grabbed and manipulated by the library accessor.

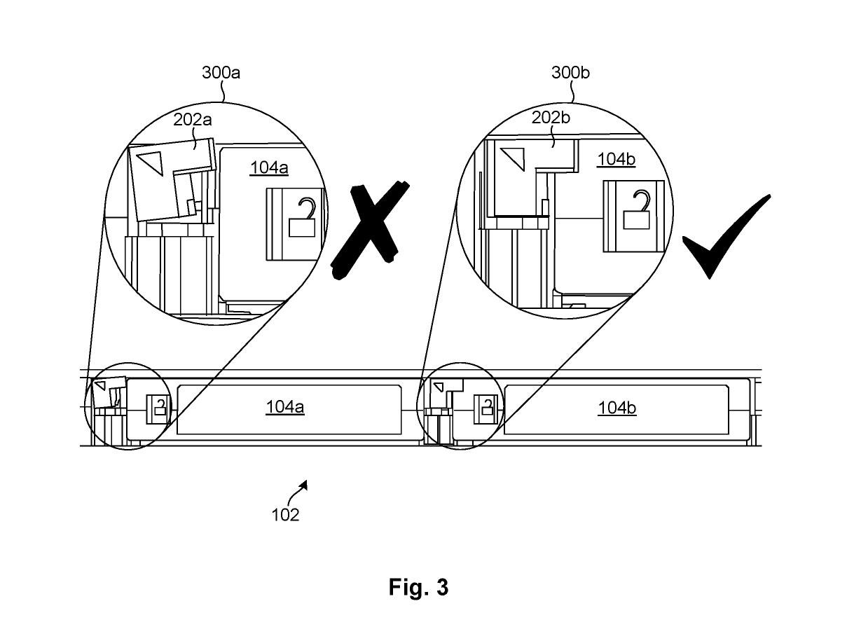

Referring to FIG. 3, unfortunately, because tape cartridges 104 are typically inserted into a tape library magazine 102 by hand, operator error may cause problems with the magazine latching function. If the operator is not diligent in pushing a tape cartridge 104 all the way into a slot 200, the latching mechanism 202 may not close completely. This may create a partial latch condition. If a tape cartridge 104 is not fully latched, the latching mechanism 202 may open at unexpected times, allowing the tape cartridge 104 to protrude out of the tape library magazine 102 beyond the latch point. This may occur when the tape library magazine 102 is subjected to shock or vibration, such as when the magazine 102 is inserted into the tape library 100. If the latch 202 opens when the magazine 102 is inserted into the tape library 100, the tape cartridge 104 may protrude from the tape library magazine 102 in a way that prevents removal of the tape library magazine 102 from the tape library 100. A protruding tape cartridge 104 may also interfere with movement of an accessor inside the tape library 100, possibly causing an accessor movement error. Any of these scenarios has the potential to interfere with a scheduled backup and/or prevent a customer from accessing its data. In certain cases, the scenarios described above may damage the tape library 100, potentially causing loss of the tape library 100 and/or the data contained therein.

FIG. 3 is a side view showing one example of proper and improper engagement of a latching mechanism 202 configured to retain a tape cartridge 104 within a tape library magazine 102. The latching mechanism 202b on the right-hand side of FIG. 3 (shown in blow-up detail portion 300b) shows a properly engaged latching mechanism 202b. The latching mechanism 202a on the left-hand side of FIG. 3 (shown in blow-up detail portion 300a) shows an improperly engaged latching mechanism 202a. As shown in blow-up detail portion 300b, when properly engaged, the tape cartridge 104b may be pushed into the tape library magazine 102 sufficiently to enable the latching mechanism 202b to extend over the tape cartridge 104b. This will retain the tape cartridge 104b within the tape library magazine 102 and prevent the tape cartridge 104b from releasing or protruding from a side of the tape library magazine 102. When functioning properly, the latching mechanism 202b may be disengaged, as needed, by the accessor and/or other robotics within the tape library 100 so that the tape cartridge 104b can be removed from the tape library magazine 102 and loaded into a tape drive for accessing data thereon. After data has been accessed, the tape cartridge 104b may be reloaded into the tape library magazine 102 and the latching mechanism 202b may be properly re-engaged.

As shown in blow-up detail portion 300a, when improperly engaged, the tape cartridge 104a may not be pushed into the tape library magazine 102 sufficiently to enable the latching mechanism 202a to extend over the tape cartridge 104a. Such a scenario may occur if an operator is not diligent in pushing a tape cartridge 104a all the way into a slot 200. In certain cases, the latching mechanism 202a may be partially engaged such that it only partially extends over the tape cartridge 104a. For example, the latching mechanism 202a may partially catch a curved edge of the tape cartridge 104a, or tenuously engage ridges or other surface elements on the tape cartridge 104a. In certain cases, the latching mechanism 202a may be misaligned or skewed as shown in the blow-up detail portion 300a. A vibration, shock, or other movement, may be sufficient to jar the tape cartridge 104a loose from the tape library magazine 102. This may allow the tape cartridge 104a to release or protrude from the tape library magazine 102 at unexpected or undesirable times, potentially causing the problems previously discussed.

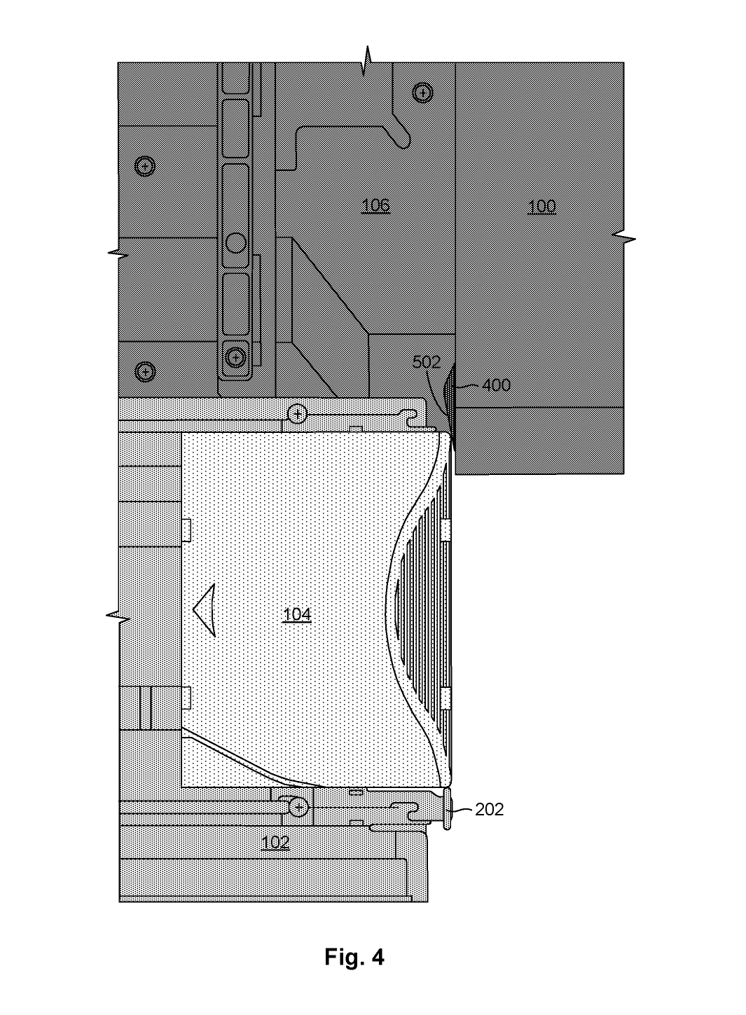

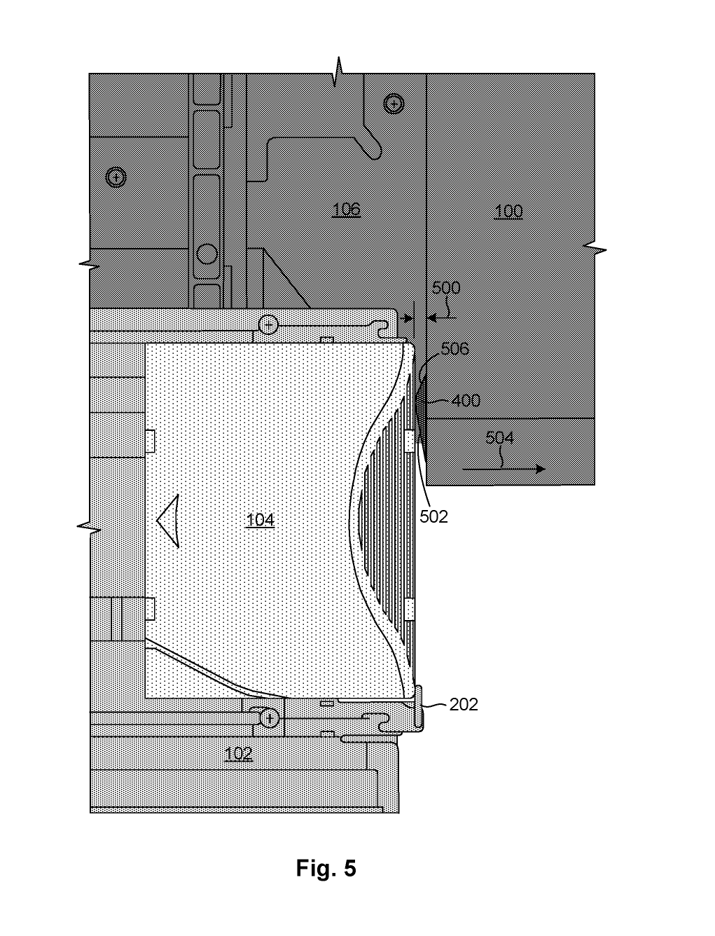

Referring to FIGS. 4 and 5, in order to prevent cases of operator error that may cause the latching malfunction and associated problems described above, a protruding member 400 may be placed within the channel 106 of the tape library 100 to urge tape cartridges 104 into the tape library magazine 102 as the tape library magazine 102 is slid into the channel 106. This will ensure that the latching mechanisms 202 properly engage the tape cartridges 104 within the tape library magazine 102.

FIG. 4 shows a tape library magazine 102 as it is being slid into a tape library 100. For illustration purposes, the tape library 100, tape library magazine 102, tape cartridge 104, and protruding member 400 are shaded differently to show the position of various components relative to one another. In the illustrated example, the tape cartridge 104 is just coming into contact with the protruding member 400. Furthermore, the tape cartridge 104 is not fully engaged by the latching mechanism 202, possibly the result of an operator not sufficiently pushing the tape cartridge 104 into the tape library magazine 102. In such a scenario, any vibration, shock, or movement, may be sufficient to jar the tape cartridge 104a loose from the tape library magazine 102. In certain cases, the very act of inserting the tape library magazine 102 into the tape library 100 may create sufficient vibration to jar the tape cartridge 104a loose from the tape library magazine 102. As previously discussed, this may cause the tape cartridge 104 to undesirably protrude from the tape library magazine 102.

As the tape library magazine 102 is slid into the tape library 100, the tape cartridge 104 comes into contact with the protruding member 400. In the illustrated embodiment, the protruding member 400 has a gradually sloped surface 502 to enable the tape cartridge 104 to slide along the protruding member 400 without catching thereon. In certain embodiments, the protruding member 400 is made of or coated with a material having a low coefficient of friction to reduce friction between the tape cartridge 104 and the protruding member 400. As the tape cartridge 104 slides along the protruding member 400, the tape cartridge 104 is pushed into the tape library magazine 102, thereby allowing the latching mechanism 202 to fully engage the tape cartridge 104. The height 500 of the protruding member 400 may be designed to push the tape cartridge 104 into the tape library magazine 102 a specified amount to engage the latching mechanism 202. FIG. 5 shows the tape library magazine 102 after the protruding member 400 has fully engaged the latching mechanism 202.

The shape and configuration of the protruding member 400 may vary in different embodiments. The illustrated shape and configuration is provided only by way of example and not limitation. For the purpose of this disclosure, any protruding structure that is designed to push a tape cartridge 104 into a tape library magazine 102 as the tape library magazine 102 is inserted into a tape library 100, regardless of its shape or form, is deemed to be a “protruding member” 400 in accordance with the invention.

Various ancillary structures may be used with the protruding member 400 or to improve operation of the protruding member 400. For example, in certain embodiments, the protruding member 400 may be coupled to a biasing member (not shown) such as a spring, elastomeric member, or the like. This biasing member may press the protruding member 400 against the tape cartridge 104 with a desired amount of force. In certain embodiments, this force may be designed to overcome the spring force exerted by the tape library magazine 102 on the tape cartridge 104. This will ensure that the tape cartridge 104 can be urged into the tape library magazine 102 to engage the latching mechanism 202.

The biasing member may also allow the protruding member 400 to be pushed away from the tape cartridge 104 and/or tape library magazine 102 when it comes into contact with more rigid structures. For example, when the latching mechanism 202 comes into contact with the protruding member 400, the protruding member 400 may move in direction 504 to enable the latching mechanism 202 to slide past the protruding member 400. Thus, the biasing member may enable the protruding member 400 to push against the tape cartridge 104 in addition to allowing the protruding member 400 to move away from more rigid structures.

The same functionality may be used when removing the tape library magazine 102 from the tape library 100. For example, a rear surface 506 of the protruding member 400 may, in certain embodiments, be sloped to enable structures to slide past the protruding member 400 when the tape library magazine 102 is removed from the tape library 100. Similarly, the biasing member previously discussed may allow the protruding member 400 to move away from rigid structures such as the latching mechanism 202 when such structures move past the protruding member 400.

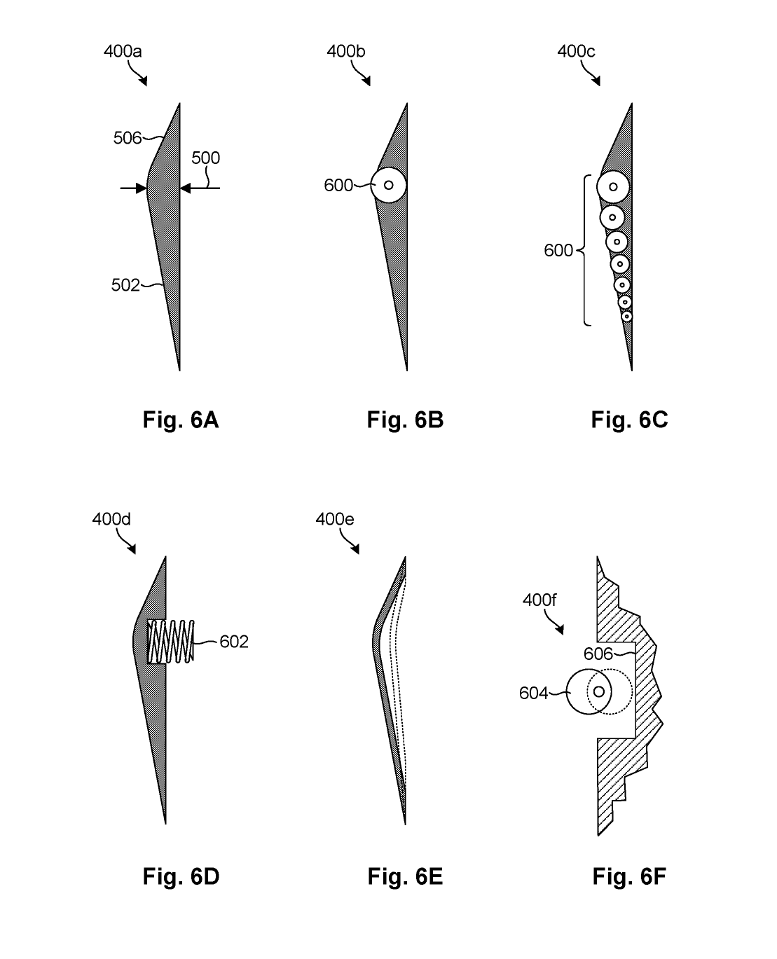

Referring to FIGS. 6A through 6F, as mentioned above, a protruding member 400 in accordance with the invention may take on various shapes and forms. Several different embodiments of a protruding member 400 are illustrated in FIGS. 6A through 6F. These embodiments are presented by way of example and not limitation. Furthermore, various features of the embodiments illustrated in FIGS. 6A through 6F may be combined into a single embodiment, or separated out into different embodiments.

In general, a protruding member 400 in accordance with the invention may take the form of a cam that pushes against a tape cartridge 104 while allowing the tape cartridge 104 to slide past. In alternative embodiments, the protruding member 400 may be embodied as an arm, aided by a biasing member or other element, that pushes against a tape cartridge 104 while allowing the tape cartridge 104 to slide past. In certain embodiments, the protruding member 400 incorporates one on or more rollers to push against the tape cartridge 104 while reducing friction with the tape cartridge 104.

FIG. 6A shows one embodiment of a cam-like protruding member 400a that pushes against a tape cartridge 104. As shown, the protruding member 400a has a gradually sloped surface 502 to enable the tape cartridge 104 to slide along the protruding member 400a while being pushed into the tape library magazine 102. A opposing surface 506 of the protruding member 400a may, in certain embodiments, also be sloped to enable structures to slide past the protruding member 400a when the tape library magazine 102 is removed from the tape library 100. As previously mentioned, the protruding member 400a may in certain embodiments be made of or coated with a material having a low coefficient of friction to allow the tape cartridge 104 to easily slide along the protruding member 400a. The height 500 of the protruding member 400a may also be designed to push the tape cartridge 104 into the tape library magazine 102 an amount sufficient to engage a latching mechanism 202.

FIG. 6B shows one embodiment of a protruding member 400b incorporating a roller 600. The protruding member 400b has a shape similar to the protruding member 400a illustrated in FIG. 6A, although other shapes and forms may be used. The roller 600 may push against a tape cartridge 104 while allowing the tape cartridge 104 to easily move past the protruding member 400b.

FIG. 6C shows a protruding member 400c that is similar to the protruding member 400b illustrated in FIG. 6B except that the protruding member 400c incorporates multiple rollers 600. These additional rollers 600 may further reduce friction between a tape cartridge 104/tape library magazine 102 and the protruding member 400c.

FIG. 6D shows one embodiment of a protruding member 400d that uses a biasing member 602 to press the protruding member 400d against a tape cartridge 104, while also allowing the protruding member 400d to deflect away from the tape cartridge 104 and/or tape library magazine 102 when it comes into contact with more rigid structures. The spring-force generated by the biasing member 602 may be designed to overcome the spring force of the tape library magazine 102, thereby enabling a tape cartridge 104 to be pushed into the tape library magazine 102. Although the biasing member 602 illustrated in FIG. 6D is embodied as a compression spring, the biasing member 602 is not limited to compression springs. For example, the biasing member 602 may be embodied as a torsion spring, leaf spring, elastomeric member, or the like. Similarly, the biasing member 602 may linearly push the protruding member 400d against the tape cartridge 104 or the biasing member 602 may cause the protruding member 400d to pivot relative to an end (or other point) of the protruding member 400d, thereby making the protruding member 400d an arm or finger that pushes against the tape cartridge 104.

FIG. 6E shows one embodiment of a protruding member 400e that also acts as a biasing member 602. In the illustrated embodiment, the protruding member 400e functions like a leaf spring that pushes against the tape cartridge 104. The protruding member 400e may flex away from the tape cartridge 104 and/or tape library magazine 102 when it comes into contact with more rigid members, such as the latching mechanism 202. The dotted lines in FIG. 6E show the protruding member 400e in a compressed/flexed condition. Alternatively, or additionally, the protruding member 400 may be configured to act as a cantilever (i.e., a beam or member fixed at one end) that pushes against a tape cartridge 104 using its own built-in bias. Such a structure may also flex or bend away from more rigid structures.

FIG. 6F shows one embodiment of a protruding member 400 embodied as a cam wheel 604 with an off-center axis of rotation. When a tape cartridge 104 rolls along the cam wheel 604, the cam wheel 604 will push the tape cartridge 104 into the tape library magazine 102 as it rotates. In certain embodiments, the cam wheel 604 is made of or coated with a material that can grip the tape cartridge 104 and cause the cam wheel 604 to rotate. As shown, the cam wheel 604 may, in certain embodiments, be provided within a recess 606 in the channel 106 of the tape library 100.

The protruding members 400a-f illustrated in FIGS. 6A through 6F are provided by way of example and not limitation. Other types of protruding members 400 are possible and within the scope of the invention. For example, it is contemplated that a protruding member 400 in accordance with the invention may be actuated by electrical current, hydraulic pressure, pneumatic pressure, or the like, to push a tape cartridge 104 into a tape library magazine 102 and thereby engage a latching mechanism 202.

The apparatus and methods disclosed herein, although described primarily in association with tape library magazines for insertion into tape libraries, may in other embodiments be extended to other types of magazines that carry items and are inserted into various types of devices. For example, the apparatus and methods disclosed herein may be applicable to magazines inserted into vending machines or to tools in a factory that dispense parts. Any type of application that requires positive latching of items within a magazine as the magazine is inserted into a device may utilize the apparatus and methods disclosed herein to ensure such latching.

The apparatus and methods disclosed herein may be embodied in other specific forms without departing from their spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus to ensure positive latching of tape cartridges in tape library magazines, the apparatus comprising:
a tape library defining a channel to receive a tape library magazine accommodating at least one tape cartridge; and
a protruding member within the channel to urge the at least one tape cartridge into the tape library magazine as the tape library magazine slides into the channel, thereby ensuring engagement of a latching mechanism configured to retain the at least one tape cartridge within the tape library magazine.

2. The apparatus of claim 1, wherein the protruding member is a cam-like member configured to push against the at least one tape cartridge.

3. The apparatus of claim 1, wherein the protruding member is an arm configured to push against the at least one tape cartridge.

4. The apparatus of claim 1, wherein the protruding member comprises a roller to push against the at least one tape cartridge.

5. The apparatus of claim 1, further comprising a biasing member to urge the protruding member against the at least one tape cartridge.

6. The apparatus of claim 5, wherein the biasing member is incorporated into the protruding member.

7. The apparatus of claim 5, wherein the biasing member allows the protruding member to move away from the tape library magazine.

8. The apparatus of claim 1, wherein the protruding member is one of made of and coated with a material having a low coefficient of friction.

9. The apparatus of claim 1, wherein the protruding member extends from a recess formed in the channel.

10. A method to ensure positive latching of tape cartridges in tape library magazines, the method comprising:
receiving, into a channel of a tape library, a tape library magazine accommodating at least one tape cartridge; and
urging, using a protruding member within the channel, the at least one tape cartridge into the tape library magazine as the tape library magazine is received into the channel, thereby ensuring engagement of a latching mechanism configured to retain the at least one tape cartridge within the tape library magazine.

11. The method of claim 10, wherein the protruding member is a cam-like member configured to push against the at least one tape cartridge.

12. The method of claim 10, wherein the protruding member is an arm configured to push against the at least one tape cartridge.

13. The method of claim 10, wherein the protruding member comprises a roller to push against the at least one tape cartridge.

14. The method of claim 10, further comprising using a biasing member to push the protruding member against the at least one tape cartridge.

15. The method of claim 14, wherein the biasing member is incorporated into the protruding member.

16. The method of claim 14, wherein the biasing member allows the protruding member to move away from the tape library magazine.

17. The method of claim 10, wherein the protruding member is one of made and coated with a material having a low coefficient of friction.

18. The method of claim 10, wherein the protruding member extends from a recess formed in the channel.

19. A system to ensure positive latching of tape cartridges in tape library magazines, the system comprising:
a tape library defining a channel to receive a magazine accommodating at least one tape cartridge; and
a protruding member within the channel to urge the at least one tape cartridge into the magazine as the tape library magazine slides into the channel, thereby ensuring engagement of a latching mechanism configured to retain the at least one tape cartridge within the magazine.

20. The system of claim 19, further comprising a biasing member to urge the protruding member against the at least one tape cartridge.
